(19) United States
(12) Patent Application Publication
(10) Pub. No.: US 2016/0153374 A1
(43) Pub. Date: Jun. 2, 2016

(54) Vehicle Control Device

(71) Applicant: HITACHI AUTOMOTIVE SYSTEMS, LTD., Ibaraki (JP)

(72) Inventor: Naoyuki TASHIRO, Tokyo (JP)

(21) Appl. No.: 14/905,096

(22) PCT Filed: May 21, 2014
(86) PCT No.: PCT/JP2014/063406

§ 371 Date: Jan. 14, 2016

(30) Foreign Application Priority Data
Jul. 29, 2013 (JP) 2013-156880

(51) Int. Cl. F02D 41/00; F02D 41/02; F02D 41/30; F02D 41/10

(52) U.S. Cl. CPC F02D 41/0002; F02D 41/10; F02D 41/0215; F02D 41/3005

(57) ABSTRACT

An object of the present invention is to provide a vehicle control device which can effectively improve fuel consumption performance of a whole vehicle by efficiently charging a battery mounted on the vehicle by suppressing deterioration of fuel consumption performance of the vehicle. The vehicle control device includes a re-acceleration prediction unit and a target value calculation unit. The re-acceleration prediction unit predicts re-acceleration from a deceleration state of a vehicle based on external environmental information. The target value calculation unit calculates, based on a prediction result by the re-acceleration prediction unit, a target throttle opening of a throttle for adjusting an amount of air flowing in an engine and a target power generation amount of a power generator for supplying power to a battery by being driven by the engine.

### TECHNICAL FIELD

The present invention relates to a vehicle control device, and for example, relates to the vehicle control device which controls fuel consumption performance of a vehicle by adjusting a load of an engine and a state of charge of a battery, which are mounted on the vehicle.

### BACKGROUND ART

Conventionally, a battery for operating an engine and other electric equipment mounted on a vehicle is charged by using electric power generated by a power generator driven by the engine. During deceleration of the vehicle, the battery is charged by driving the power generator by a reverse drive torque transmitted from a wheel to the engine by such as inertia travelling of the vehicle (called energy regeneration during deceleration). During deceleration, a vehicle is controlled so as to cut off fuel supply to the engine in consideration of fuel consumption (fuel supply cut). However, in such control, fuel supply to the engine is restarted when an engine rotation speed decreases to near idling speed.

As a conventional technique for such a control device, PTL 1 described below discloses a technique in which, power generation voltage of a power generator is controlled based on a residual amount of a battery during deceleration of an engine in which fuel supply is cut off, the battery is charged during deceleration of the engine, and also deterioration of emission is suppressed.

A power generation control device for a vehicle power generator disclosed in PTL 1 increases air flowing in an engine by controlling a throttle valve in the case where a battery residual amount is small when fuel supply to the engine is cut off until an engine rotation speed decreases to a fuel supply reset rotation speed from start of deceleration.

According to the power generation control device for the vehicle power generator disclosed in PTL 1, air flowing in an engine is increased only in the case where a battery residual amount is small. Therefore, low-temperature air flowing in the engine is less likely to be sent to a catalyst, and deterioration of emission by degradation of exhaust emission control performance in association with catalyst temperature drop can be suppressed.

### CITATION LIST

### Patent Literature

PTL 1: JP 2009-257170 A

### SUMMARY OF INVENTION

### Technical Problem

When an engine is stopped by cutting off fuel supply to the engine, and a driving force is generated to a vehicle from a state in which the vehicle is coasted by releasing a clutch, it is necessary to control a throttle valve to a predetermined opening position (near fully closed position) in accordance with an accelerator pedal stepping amount and to refasten the clutch by starting the engine.

In the power generation control device for the vehicle power generator disclosed in PIT, 1, air flowing in an engine is increased by opening a throttle valve in the case where a battery residual amount is small. For example, when an accelerator pedal is stepped, and a vehicle is re-accelerated from a state in which the throttle valve is opened, and the vehicle is coasting, it takes time to return the throttle valve to a predetermined opening position (near fully closed position) in accordance with a stepping amount of the accelerator pedal. Accordingly, intake response is delayed, and an amount of air flowing in a cylinder of the engine becomes excessive, and fuel consumption performance of the vehicle is degraded.

An object of the present invention is, in view of the above issue, to provide a vehicle control device which can effective improve fuel consumption performance of a whole vehicle by efficiently charging a battery mounted on the vehicle while suppressing degradation of fuel consumption performance of the vehicle even in the case where an accelerator pedal is stepped, and the vehicle is re-accelerated from a coasting state of the vehicle.

### Solution to Problem

To solve the above-described issue, a vehicle control device according to the present invention controls fuel consumption performance of a vehicle by adjusting a load of an engine and a state of charge of a battery which are mounted on the vehicle, and the vehicle control device includes a re-acceleration prediction unit and a target value calculation unit. The re-acceleration prediction unit predicts re-acceleration from a deceleration state of the vehicle based on external environmental information. The target value calculation unit calculates, based on a prediction result by the re-acceleration prediction unit, a target throttle opening of a throttle for adjusting an amount or air flowing in the engine and a target power generation amount of a power generator for supplying power to the battery by being driven by the engine.

### Advantageous Effects of Invention

A vehicle control device according to the present invention predicts re-acceleration from a deceleration state of a vehicle based on external environmental information and calculates, based on the prediction result, a target throttle opening of a throttle and a target power generation amount of a power generator. Accordingly, even in the case where an accelerator pedal is stepped, and a vehicle is re-accelerated from a coasting state of the vehicle, for example, the throttle can be appropriately controlled to a predetermined opening position (near fully closed position) in accordance with an accelerator pedal stepping amount, regeneration energy of a battery can be effectively improved, and a battery mounted on a vehicle can be efficiently charged while suppressing degradation of fuel consumption performance of the vehicle.

An issue, a configuration, and an effect other than the above are clarified by descriptions of the following embodiments.

### BRIEF DESCRIPTION OF DRAWINGS

FIG. 1 is an overall configuration diagram schematically illustrating a system configuration of a vehicle including a first embodiment of a vehicle control device according to the present invention.

FIG. 2 is an internal configuration diagram schematically illustrating an internal configuration of an engine illustrated in FIG. 1.

FIG. 3 is an internal configuration diagram schematically illustrating an internal configuration of a controller illustrated in FIG. 1.

FIG. 4 is a flowchart describing a calculation flow by a fuel supply amount calculation unit illustrated in FIG. 3.

FIG. 5 is a flowchart describing a calculation flow by a target throttle opening calculation unit illustrated in FIG. 3.

FIG. 6 is a time chart illustrating, in a time series, an example of an accelerator pedal stepping amount, a fuel supply amount, a re-acceleration prediction result, and a throttle opening.

FIG. 7 is a flowchart describing a calculation flow by a target power generation amount calculation unit illustrated in FIG. 3.

FIG. 8 is a schematic diagram schematically describing a method for calculating a target power generation amount by the target power generation amount calculation unit illustrated in FIG. 3.

FIG. 9 is an internal configuration diagram schematically illustrating an internal configuration of a second embodiment of the vehicle control device according to the present invention.

FIG. 10 is a schematic diagram schematically describing a method for calculating a target driving force by a target driving force calculation unit illustrated in FIG. 9.

FIG. 11 is a schematic diagram schematically describing a method for calculating a target throttle opening by a target throttle opening calculation unit illustrated in FIG. 9.

FIG. 12 is a time chart illustrating, in a time series, an example of an accelerator pedal stepping amount, a vehicle speed, a battery residual capacity, and a throttle opening.

FIG. 13 is an internal configuration diagram schematically illustrating an internal configuration of a third embodiment of the vehicle control device according to the present invention.

FIG. 14 is a flowchart describing a calculation flow by a target driving force calculation unit illustrated in FIG. 13.

FIG. 15 is a time chart illustrating, in a time series, an example of an accelerator pedal stepping amount, a vehicle speed, an acceleration, and a throttle opening.

FIG. 16 is an internal configuration diagram schematically illustrating an internal configuration of a fourth embodiment of the vehicle control device according to the present invention.

FIG. 17 is an internal configuration diagram schematically illustrating an internal configuration of a transmission.

FIG. 18 is a flowchart describing a calculation flow by a power transmission state calculation unit illustrated in FIG. 16.

FIG. 19 is a flowchart describing a calculation flow by a target throttle opening calculation unit illustrated in FIG. 16.

FIG. 20 is a flowchart describing a calculation flow by a target power generation amount calculation unit illustrated in FIG. 16.

FIG. 21 is a time chart illustrating, in a time series, an example of an accelerator pedal stepping amount, a throttle opening, a power transmission state, a vehicle speed, and a distance to a target stop position.

### DESCRIPTION OF EMBODIMENTS

Embodiments of a vehicle control device according to the present invention will be described below with reference to the drawings.

### First Embodiment

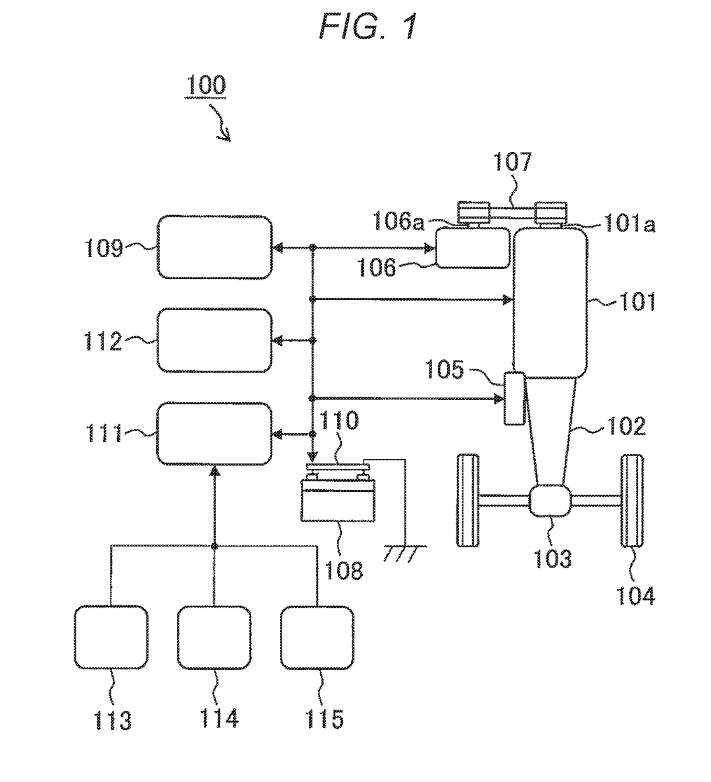

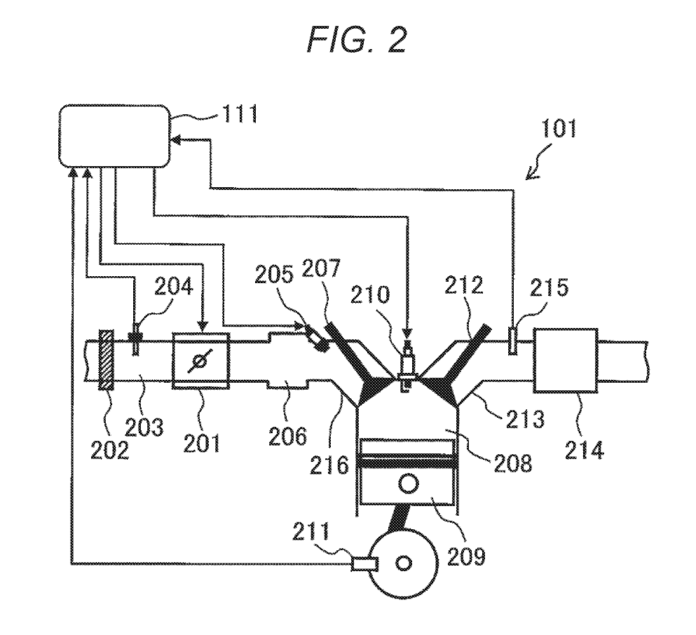

FIG. 1 schematically illustrates a system configuration of a vehicle including a first embodiment of a vehicle control device according to the present invention. Further, FIG. 2 schematically illustrates an internal configuration of an engine illustrated in FIG. 1.

As illustrated in FIG. 1, an engine 101 is mounted on a vehicle 100, and a driving force provided by the engine 101 is transmitted to a drive wheel 104 via a transmission 102 and a differential mechanism 103. As the engine 101, a gasoline engine and a diesel engine can be applied which are generally used as a power source of an automobile. Further, examples of the transmission 102 include a stepped transmission in which a torque converter and a planetary gear mechanism are combined, and a stepless transmission in which a belt or a chain and a pulley are combined.

A starter motor 105 as a starting device is assembled in the engine 101, and also a power generator 106 is connected to the engine 101 via a driving belt 107. Further, the starter motor 105 and the power generator 106 are connected to a battery 108 for power supply, and also the starter motor 105, the power generator 106, and the engine 101 are communicativeiy connected to a controller (vehicle control device) 111 which controls driving thereof.

The starter motor 105 is rotationally driven by power supplied from the battery 108, and the engine 101 is rotationally driven in conjunction with rotational driving of the starter motor 105. A starting device of the engine 101 is not limited to the starter motor 105, and a motor having functions of a starter motor and a power generator may be used.

Further, a crank shaft 101a of the engine 101 is connected to a crank shaft 106a of the power generator 106 via the driving belt 107. The power generator 106 is rotationally driven by following rotation of the crank shaft 101a of the engine 101 and generates power. Further, the power generator 106 includes an adjustment mechanism for adjusting power generation voltage by controlling a field current and a stop mechanism for stopping power generation output. Power generated by the power generator 106 is supplied to such as the battery 108, an in-vehicle electrical equipment 109, an external environmental information acquisition device 112, and the controller 111.

A battery state detector 110 is assembled in the battery 108. The battery state detector 110 detects a state of the battery 108. The battery state detector 110 includes, for example, a voltage sensor for detecting voltage of the battery 108, a current sensor for detecting charging current or discharge current from the battery 108, and a temperature sensor for detecting a temperature of the battery 108. The battery state detector 110 calculates a state of charge (for example, a battery residual capacity) of the battery 108 based on information provided from each of the sensors and sends a result of the calculation to the controller 111. For example, a residual capacity SOC (State of Charge) of the battery 108 is calculated based on such as charge/discharge current to the battery 108 and a voltage of the battery 108. Examples of the battery 108 include a lead battery, a nickel-hydrogen battery, a lithium ion battery, and a capacitor. The battery may be formed by parallelly connecting batteries having different characteristics among those batteries.

The in-vehicle electrical equipment 109 is driven by power supplied from the power generator 106 and the battery 108. The in-vehicle electrical equipment 109 includes, for example, each type of an actuator for operating the engine 101 (for example, a fuel supply device and an ignitor), a head light, a brake lamp, a lighting device such as a direction indicator, and an air conditioner such as a blower fan and a heater. Each of the devices is communicatively connected to the controller 111.

Further, the external environmental information acquisition device 112 obtains external environmental information around the vehicle 100. The external environmental information acquisition device 112 includes, for example, a navigation system, a camera, a radar, and an inter-vehicle communication module or a road-vehicle communication module. The external environmental information provided from the external environmental information acquisition device 112 is periodically sent to the controller 111.

Further, an accelerator pedal stepping amount detector 113, a brake pedal stepping amount detector 114, and a vehicle speed detector 115 are mounted on the vehicle 100. The accelerator pedal stepping amount detector 113 detects a stepping amount of an accelerator pedal. The brake pedal stepping amount detector 114 detects a stepping amount of a brake pedal. The vehicle speed detector 115 detects a speed of the vehicle 100. Information detected by such as the accelerator pedal stepping amount detector 113, the brake pedal stepping amount detector 114, and the vehicle speed detector 115 are periodically sent to the controller 111.

An operation state of the above-described engine 101 is summarized with reference to FIG. 2. First, an opening (throttle opening) of an electrically controlled throttle 201 is adjusted by the controller 111, a negative pressure is generated in an intake pipe 203, and air is taken in the intake pipe 203. Air taken from an inlet of the intake pipe 203 passes through an air cleaner 202 and is introduced to an inlet of the electrically controlled throttle 201 after an air amount (intake air amount) is measured by an airflow sensor 204 provided in the middle of the intake pipe 203. A measurement value (intake air amount) by the airflow sensor 204 is sent to the controller 111. The controller 111 calculates, based on the intake air amount sent from the airflow sensor 204, fuel injection pulse width of a fuel injector 205 so that an air fuel ratio of exhaust gas becomes a theoretical air fuel ratio.

Intake air which has passed through the electrically controlled throttle 201 is introduced in an intake manifold 216 after passing through a collector 206 and forms fuel air mixture by mixing with gasoline spray emitted from the fuel injector 205 in accordance with a control signal regarding the fuel injection pulse width. The fuel air mixture is introduced in a combustion chamber 208 in synchronization with opening/closing of the intake valve 207. The fuel air mixture compressed in the combustion chamber 208 while a piston 209 is ascending in a state in which the intake valve 207 is closed is ignited around just before a top dead center by an ignition plug 210 ignited in accordance with an ignition timing sent from the controller 111, and the fuel air mixture generates an engine torque by pushing down the piston 209 by rapidly inflating in the combustion chamber 208. By repeating such a process, rotation of the engine 101 is maintained. In such a case, a rotation speed of the engine 101 is detected by a crank angle sensor 211 and sent to the controller 111.

Exhaust gas generated in the combustion chamber 208 since the fuel air mixture is burned is discharged from the combustion chamber 208 and exhausted to an exhaust manifold 213 from the moment when the piston 209 ascends and an exhaust valve 212 opens. A three-way catalyst 214 for purifying exhaust gas is provided in a downstream of the exhaust manifold 213. When the exhaust gas passes through the three-way catalyst 214, exhaust components such as HC, CO, and NOx are converted to H2O, CO2, and N2. An air fuel ratio sensor 215 is provided at an inlet of the three-way catalyst 214. Information on an air fuel ratio measured by the air fuel ratio sensor 215 is sent to the controller 111. The controller 111 performs air fuel ratio feedback control so that an air fuel ratio of exhaust gas becomes a theoretical air fuel ratio based on information sent from the air fuel ratio sensor 215.

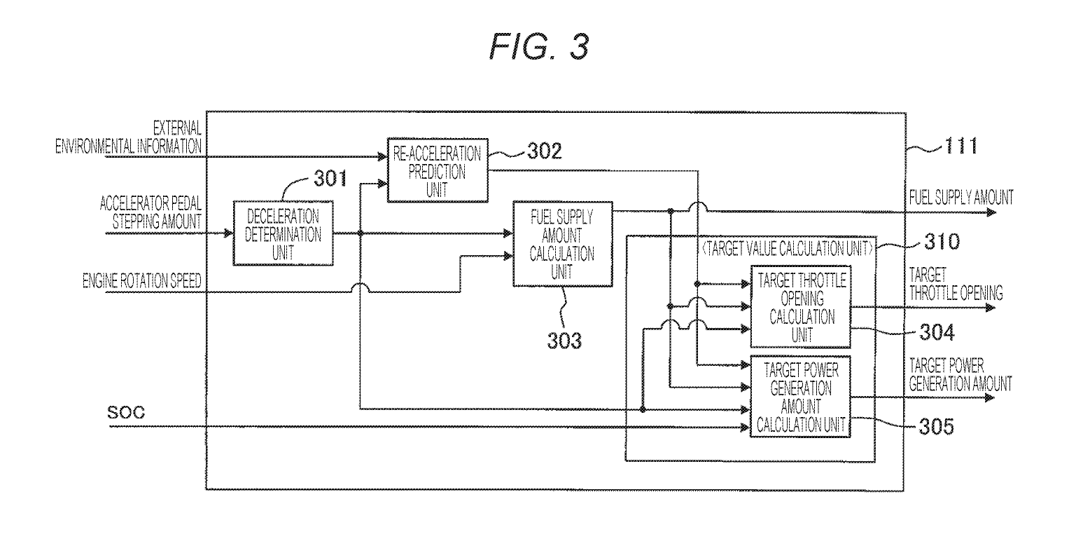

FIG. 3 schematically illustrates an internal configuration of a controller illustrated in FIG. 1. As illustrated, the controller 111 mainly includes a deceleration determination unit 301, a re-acceleration prediction unit 302, a fuel supply amount calculation unit 303, and the target value calculation unit 310. The target value calculation unit 310 includes a target throttle opening calculation unit 304 and a target power generation amount calculation unit 305.

The deceleration determination unit 301 determines whether the vehicle 100 is in a deceleration state, based on a brake pedal stepping amount detected by the accelerator pedal stepping amount detector 113. Specifically, when the deceleration determination unit 301 detects that an accelerator pedal stepping amount is zero, it determines that “the vehicle 100 is in a deceleration state”. When the deceleration determination unit 301 detects that the accelerator pedal stepping amount is not zero, it determines that “the vehicle 100 is not in a deceleration state”.

The re-acceleration prediction unit 302 determines based on a determination result sent from the deceleration determination unit 301 whether the vehicle 100 is in a deceleration state. When it is determined that the vehicle 100 is in a deceleration state (an accelerator pedal stepping amount is zero), the re-acceleration prediction unit 302 predicts whether the vehicle 100 can re-accelerate from a deceleration state, based on external environmental information on the vehicle 100, which is provided by the external environmental information acquisition device 112.

Specifically, the re-acceleration prediction unit 302 determines that the vehicle 100 is likely to re-accelerate, for example, when an inter-vehicle distance between an own vehicle and a front vehicle is equal to or larger than a predetermine value, and a relative speed between the own vehicle and the front vehicle is negative. The relative speed is a value obtained by subtracting a speed of a front vehicle from a speed of an own vehicle. When the value is positive, the speed of the own vehicle is faster than the speed of the front vehicle, and therefore the own vehicle is approaching to the front vehicle. When the value is negative, the speed of the own vehicle is slower than the speed of the front vehicle, and therefore the own vehicle is leaving from the front vehicle. Further, the re-acceleration prediction unit 302 determines that the vehicle 100 is likely to re-accelerate, for example, when an inter-vehicle distance between an own vehicle and a front vehicle is equal to or larger than a predetermine value, and an acceleration speed of the front vehicle is equal to or larger than a predetermined value. Further, for example, when a driver operates such as a winker and a handle, the re-acceleration prediction unit 302 determines that an own vehicle is likely to pass a front vehicle and determines that the vehicle 100 is likely to re-accelerate. Specifically, the re-acceleration prediction unit 302 determines that the vehicle 100 is likely to re-accelerate when a winker switch is ON and when a steering angle of a handle is equal to or larger than a predetermined value. Further, the re-acceleration prediction unit 302 determines that the vehicle 100 is likely to re-accelerate, for example, when a vehicle is not detected in front of the vehicle 100.

Further, each device included in the external environmental information acquisition device 112 includes a defect detection function, and information on a defect of each device, detected by the defect detection function, is sent to the controller 111. The re-acceleration prediction unit 302 determines that the vehicle 100 is likely to re-accelerate when it determines based on the information on a defect of each device sent from the external environmental information acquisition device 112 that any one of or a plurality of devices in the external environmental information acquisition device 112 has a defect. Therefore, deterioration in operability of the vehicle 100, stop of the engine 101, and degradation of fuel consumption performance by such as repeated restart of the engine 101 can be suppressed.

The fuel supply amount calculation unit 303 calculates a fuel supply amount based on a determination result sent from the deceleration determination unit 301 and a rotation speed of the engine 101, which is detected by the crank angle sensor 211, and a control signal based on a result of the calculation (fuel supply amount) is sent to the engine 101.

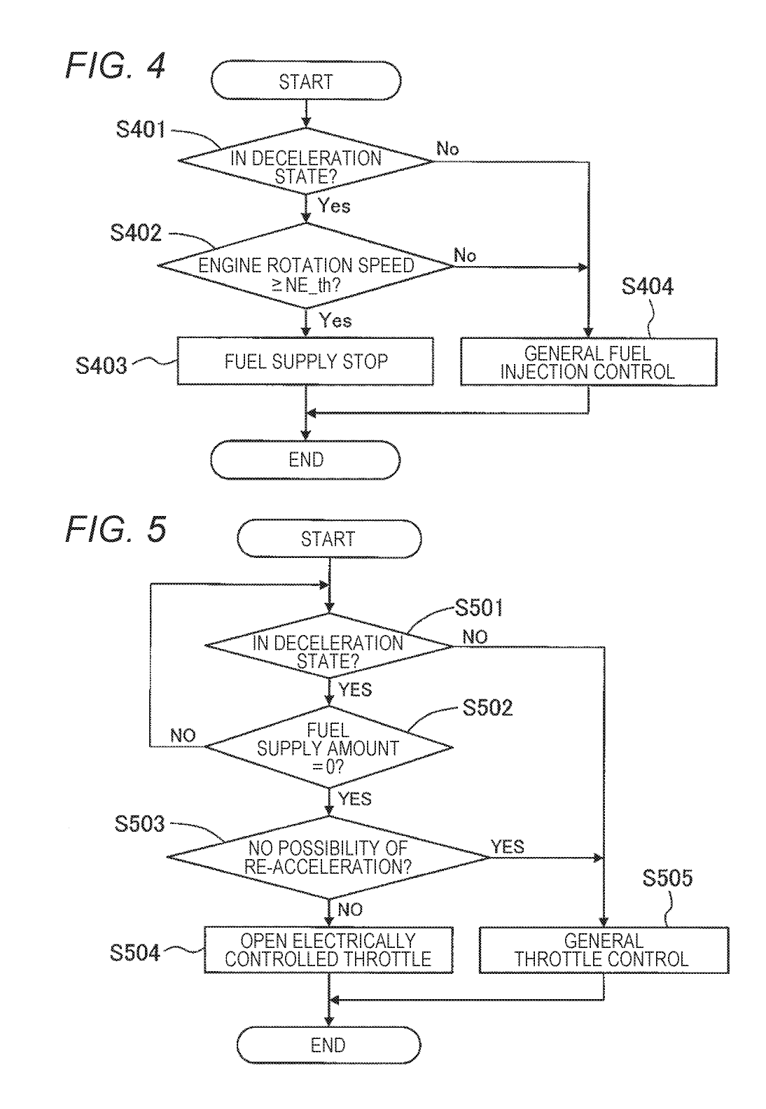

Specifically, the fuel supply amount calculation unit 303, as illustrated in FIG. 4, determines based on a determination result sent from the deceleration determination unit 301 whether the vehicle 100 is in a deceleration state (S401). When the fuel supply amount calculation unit 303 determines that the vehicle 100 is in a deceleration state, the fuel supply amount calculation unit 303 determines whether a rotation speed of the engine 101 which is detected by the crank angle sensor 211 is equal to or larger than a predetermined value NE_th (S402). Next, when the fuel supply amount calculation unit 303 determines that a rotation speed of the engine 101 is equal to or larger than a predetermined value NE_th, fuel supply to the engine 101 is stopped, and the engine 101 is brought into an idling state (S403). On the other hand, when the fuel supply amount calculation unit 303 determines that the vehicle 100 is not in a deceleration state and when it determines that a rotation speed of the engine 101 is lower than the predetermined value NE_th, general fuel injection control is performed, for example, in accordance with an accelerator pedal stepping amount (S404). The predetermined value NE_th is, for example, set to a rotation speed at which a rotation of the engine 101 can be maintained, when fuel supply is restarted from a fuel supply stop state, and the fuel is ignited by the ignition plug 210.

Based on a determination result sent from the deceleration determination unit 301, a calculation result (a fuel supply amount) sent from the fuel supply amount calculation unit 303, and a prediction result sent from the re-acceleration prediction unit 302, the target throttle opening calculation unit 304 of the target value calculation unit 310 calculates an opening of the electrically controlled throttle 201 which adjusts an air amount (intake air amount) flew in the engine 101, and sends a control signal based on a result of the calculation (target throttle opening) to the electrically controlled throttle 201 of the engine 101.

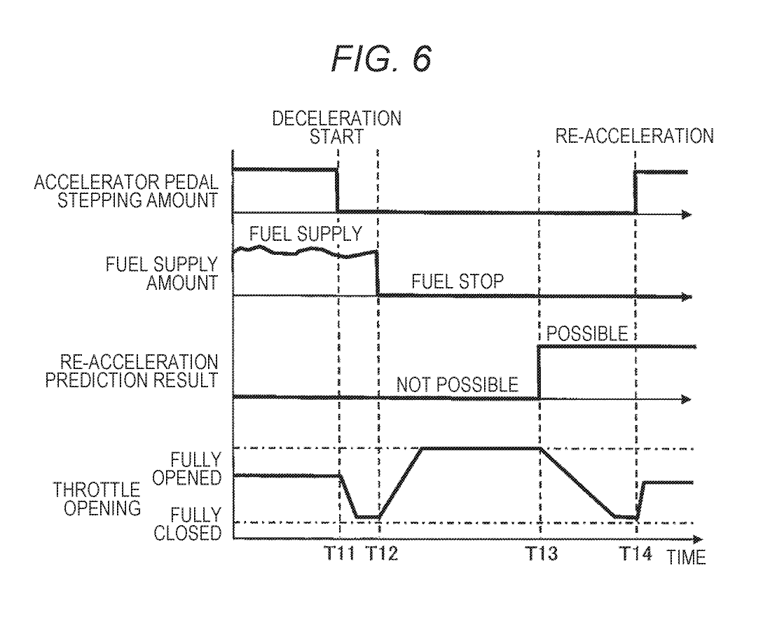

Specifically, the target throttle opening calculation unit 304, as illustrated in FIG. 5, determines based on a determination result sent from the deceleration determination unit 301 whether the vehicle 100 is in a deceleration state (S501). When the target throttle opening calculation unit 304 determines that the vehicle 100 is in a deceleration state, it determines whether a fuel supply amount sent from the fuel supply amount calculation unit 303 is zero (S502). When it is determined that the vehicle 100 is in a deceleration state, an accelerator pedal stepping amount becomes zero, and an opening of the electrically controlled throttle 201 is reduced to an almost fully closed position and maintained until a fuel supply amount becomes zero (time T11 to T12 illustrated in FIG. 6).

Next, when the target throttle opening calculation unit 304 determines that a fuel supply amount is zero, it determines based on a prediction result sent from the re-acceleration prediction unit 302 whether the vehicle 100 is likely to re-accelerate from a deceleration state (S503). When the target throttle opening calculation unit 304 determines that the vehicle 100 is not likely to re-accelerate, the electrically controlled throttle 201 is gradually opened from a near fully closed position to, for example, a full open state (S504) (time T12 to T13 illustrated in FIG. 6).

On the other hand, when it is determined that the vehicle 100 is not in a deceleration state and when it is determined that the vehicle 100 is likely to re-accelerate, general throttle control is performed, for example, in accordance with an accelerator pedal stepping amount (S505). For example, when it is determined that the vehicle 100 is in a deceleration state (an accelerator pedal stepping amount of is zero) and when it is determined that the vehicle 100 is likely to re-accelerate, the electrically controlled throttle 201 is maintained at a near fully closed position. Further, for example, in the case where it is determined that the vehicle 100 is likely to re-accelerate after it is determined that the vehicle 100 is not likely to re-accelerate, and the electrically controlled throttle 201 is opened to a full open state, and in the case where an accelerator pedal stepping amount is zero, the electrically controlled throttle 201 is gradually closed to a near fully closed position (time T13 to T14 illustrated in FIG. 6).

Thus, in the case where opening of the electrically controlled throttle 201 (target throttle opening) is largely set when it is determined that the vehicle 100 is not likely to re-accelerate, degradation of fuel consumption performance of the vehicle 100, caused by re-acceleration of the vehicle 100, can be suppressed while reducing a pumping loss of the engine 101 and reducing engine friction. Further, torque shock in association with rapid decrease in engine friction can be prevented by gradually opening the electrically controlled throttle 201.

In a small region in which an opening of the electrically controlled throttle 201 is small, a variable amount of pumping loss of the engine 101 with respect to an opening of the electrically controlled throttle 201 is increased, and torque shock in association with a decrease in engine friction is likely to be increased. Therefore, when fuel supply to the engine 101 is stopped, the target throttle opening calculation unit 304 preferably opens and closes the electrically controlled throttle 201 so that an increase amount and a decrease amount (an opening/closing speed of the electrically controlled throttle 201) per unit time of an opening in a region in which an opening of the electrically controlled throttle 201 is small is smaller than an opening/closing speed of the electrically controlled throttle 201 in a region in which opening of the electrically controlled throttle 201 is large.

Further, based on a determination result sent from the deceleration determination unit 301, a residual capacity SOC of the battery 108 sent from the battery state detector 110, a calculation result (a fuel supply amount) sent from the fuel supply amount calculation unit 303, and a prediction result sent from the re-acceleration prediction unit 302, the target power generation amount calculation unit 305 of the target value calculation unit 310 calculates a power generation amount of the power generator 106 which adjusts a state of charge of the battery 108 and sends a control signal based on a result of the calculation (target power generation amount) to the power generator 106.

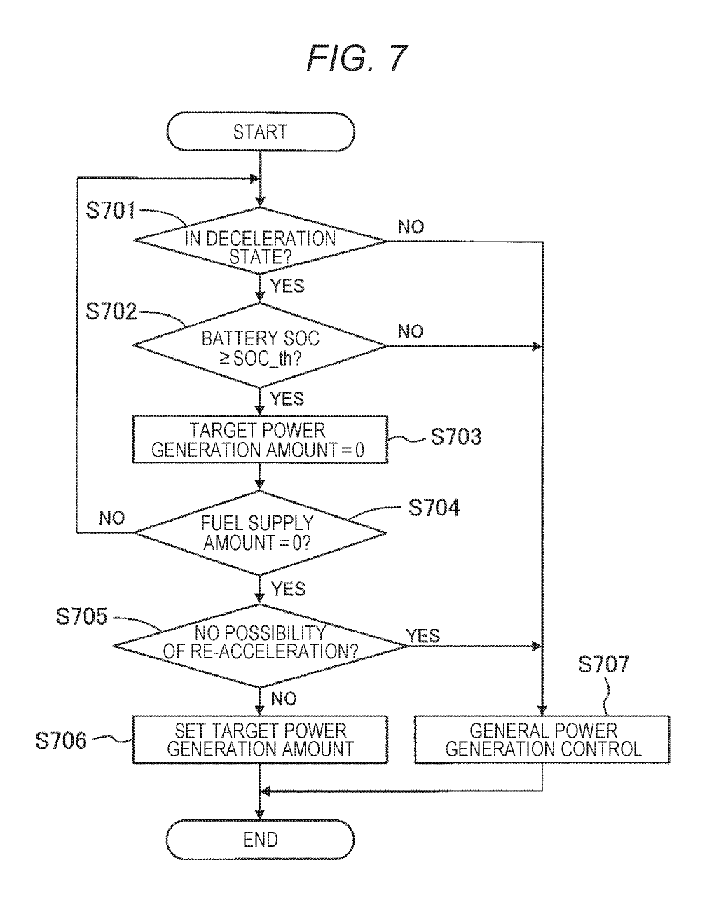

Specifically, the target power generation amount calculation unit 305, as illustrated in FIG. 7, determines based on a determination result sent from the deceleration determination unit 301 whether the vehicle 100 is in a deceleration state (S701). When it is determined that the vehicle 100 is in a deceleration state, the target power generation amount calculation unit 305 determines whether a residual capacity SOC of the battery 108 is equal to or greater than a predetermined value SOC_th (S702). The predetermined value SOC_th is, for example, set to a value by which the battery 108 does not become an over-discharge state and a value by which the battery 108 is not further deteriorated.

Next, when the target power generation amount calculation unit 305 determines that the residual capacity SOC of the battery 108 is equal to or greater than the predetermined value SOC_th, it determines that the residual capacity SOC of the battery 108 is sufficient and controls the power generator 106 to stop power generation. Specifically, a power generation amount (target power generation amount) of the power generator 106 is set to zero (S703). Accordingly, a load to the engine 101 is lowered, and fuel consumption can be suppressed.

Next, the target power generation amount calculation unit 305 determines whether a fuel supply amount sent from the fuel supply amount calculation unit 303 is zero (S704). When the target power generation amount calculation unit 305 determines that the fuel supply amount is zero, it determines based on a prediction result sent from the re-acceleration prediction unit 302 whether the vehicle 100 is likely to re-accelerate from a deceleration state (S705). When the target power generation amount calculation unit 305 determines that the vehicle 100 is not likely to re-accelerate, a target power generation amount is set so that a power generation amount of the power generator 106 becomes maximum (S706).

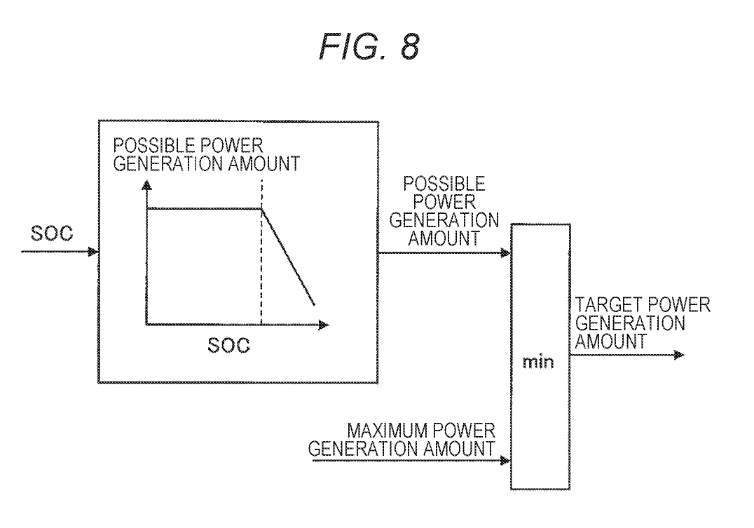

In the power generator 106, a possible power generation amount is varied in accordance with a rotation speed thereof. Therefore, the target power generation amount calculation unit 305 calculates in advance a maximum power generation amount which can be generated by the power generator 106 in accordance with the rotation speed of the power generator 106. Further, a power (battery chargeable power) acceptable from the power generator 106 to the battery 108 becomes small as the residual capacity SOC of the battery 108 is increased, and the power amount becomes constant when the residual capacity SOC of the battery 108 becomes a predetermined value or less. Therefore, the target power generation amount calculation unit 305 calculates in advance a battery chargeable power in accordance with the residual capacity SOC of the battery 108. As a target power generation amount, the target power generation amount calculation unit 305 sets a smaller value between a maximum power generation amount and a battery chargeable power amount, which are calculated in advance (see FIG. 8). The battery chargeable power is defined by performance of the battery 108.

On the other hand, when the target power generation amount calculation unit 305 determines that the vehicle 100 is not in a deceleration state, when it determines that the residual capacity SOC of the battery 108 is lower than the predetermined value SOC_th, and when it determines that the vehicle 100 is likely to re-accelerate, the target power generation amount calculation unit 305 performs general power generation control in accordance with, for example, an accelerator pedal stepping amount and the residual capacity SOC of the battery 108 (S707). For example, while the vehicle 100 is accelerating, a target power generation amount of the power generator 106 is set to zero so that a load of the engine 101 is not increased. When a residual capacity SOC of the battery 108 is lower than the predetermined value SOC_th, a target power generation amount of the power generator 106 with respect to the battery 108 is increased to charge the battery 108 so that the battery 108 does not become an over-discharging state or is not further deteriorated. Further, when the residual capacity SOC of the battery 108 becomes larger than another predetermined value SOC_th2, a target power generation amount of the power generator 106 may be set to zero.

Thus, when it is determined that the vehicle 100 is not likely to re-accelerate, a target power generation amount is set so that a power generation amount of the power generator 106 becomes maximum. Accordingly, while suppressing degradation of fuel consumption performance of the vehicle 100, caused by re-acceleration of the vehicle 100, kinetic energy can be recovered at the maximum as electric energy in a state in which a fuel supply amount to the engine 101 is zero, and fuel consumption of the vehicle 100 can be further improved.

The controller 111 according to the first embodiment predicts whether the vehicle 100 is likely to re-accelerate from a deceleration state by using external environmental information around the vehicle 100 provided by the external environmental information acquisition device 112, and then opens the electrically controlled throttle 201. Accordingly, fuel consumption performance degradation by re-acceleration of the vehicle 100 can be suppressed while reducing pumping loss and engine friction of the engine 101 and reducing kinetic energy loss of the vehicle 100. Further, in a state in which kinetic energy loss of the vehicle 100 is reduced, power generation amount of the power generator 106 is largely set. Therefore, recovery energy recovered by the battery 108 can be effectively increased, and whole fuel consumption performance of the vehicle 100 can be remarkably increased.

### Second Embodiment

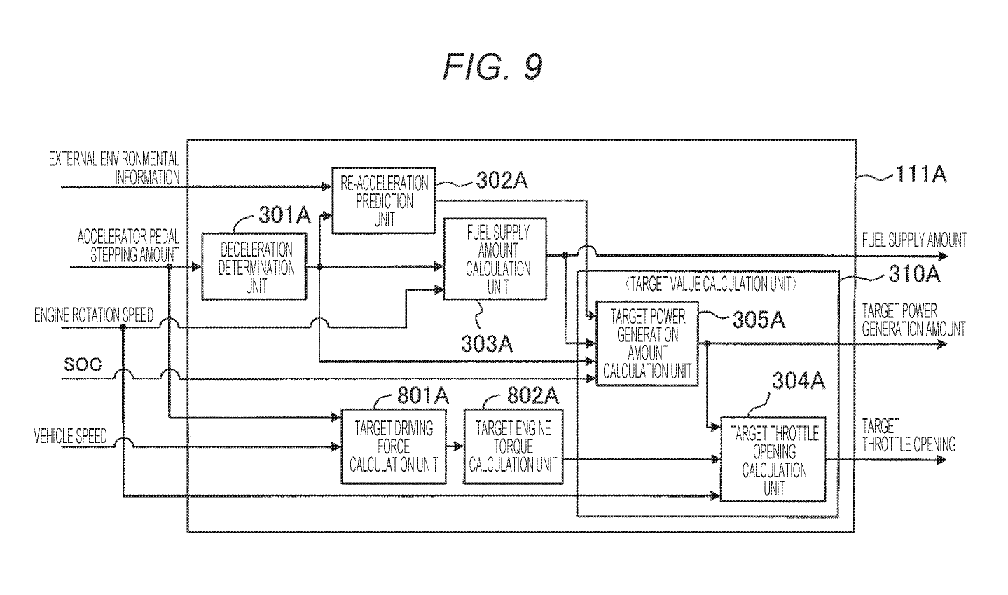

FIG. 9 schematically illustrates an internal configuration of a second embodiment of a vehicle control device according to the present invention. In a vehicle control device according to the second embodiment, mainly a configuration of a target value calculation unit is different from that of the vehicle control device according to the first embodiment, and other configurations are same as those of the vehicle control device according to the first embodiment. Therefore, the same configurations as those of the vehicle control device according to the first embodiment are denoted by the same reference signs, and detailed descriptions thereof are omitted.

As illustrated, the controller 111A mainly includes a deceleration determination unit 301A, a re-acceleration prediction unit 302A, a fuel supply amount calculation unit 303A, a target driving force calculation unit 801A, a target engine torque calculation unit 802A, and a target value calculation unit 310A. The target value calculation unit 310A includes a target throttle opening calculation unit 304A and a target power generation amount calculation unit 305A.

The target driving force calculation unit 801A calculates a target driving force based on an accelerator pedal stepping amount detected by an accelerator pedal stepping amount detector 113 and a vehicle speed of a vehicle 100 detected by a vehicle speed detector 115.

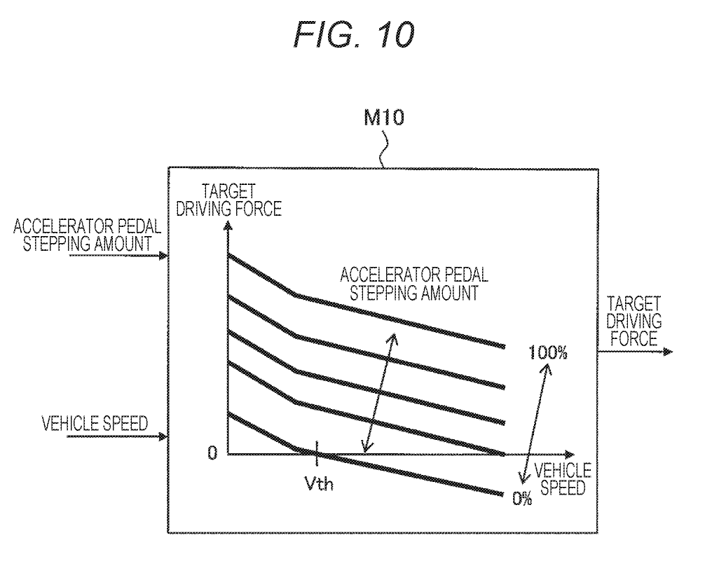

Specifically, the target driving force calculation unit 801A is, as illustrated in FIG. 10, calculates a target driving force based on a map M10 for specifying a relation among an accelerator pedal stepping amount memorized in advance and a vehicle speed of the vehicle 100, and a target driving force. This map M10 is set so that a positive target driving force is output when an accelerator pedal stepping amount is zero and when a vehicle speed of the vehicle 100 is less than a predetermined value Vth, and a negative target driving force is output when a vehicle speed of the vehicle 100 is equal to or greater than the predetermined value Vth. The predetermined value Vth is set to a vehicle speed which generates creep torque. Accordingly, a target driving force corresponds to creep torque when an accelerator pedal stepping amount is zero and when a vehicle speed of the vehicle 100 is less than a predetermined value Vth, and the target driving force corresponds to an engine brake when a vehicle speed of the vehicle 100 is equal to or greater than the predetermined value Vth.

By the following formula 1, the target engine torque calculation unit 802A calculates a target engine torque TG_T based on a target driving force TG_F sent from the target driving force calculation unit 801A, a gear ratio Gt of a transmission 102, a gear ratio Gf of a differential mechanism 103, and an outer diameter Tr of a drive wheel 104, which are memorized in advance.

$$\begin{matrix}[ Mathematical Formula 1 ] & \\ TG\_T = \frac{TG\_F}{Gt \cdot Gf / Tr} & ( 1 )\end{matrix}$$

As with the above-described first embodiment, based on a determination result sent from the deceleration determination unit 301A, a residual capacity SOC of a battery 108 sent from a battery state detector 110, a calculation result (fuel supply amount) sent from the fuel supply amount calculation unit 303A, and a prediction result sent from the re-acceleration prediction unit 302A, a target power generation amount calculation unit 305A of the target value calculation unit 310A calculates a power generation amount of a power generator 106 which adjusts a state of charge of the battery 108 and sends a control signal based on a result of the calculation (target power generation amount) to the power generator 106.

Based on a target engine torque sent from the target engine torque calculation unit 802A, a target power generation amount sent from the target power generation amount calculation unit 305A, and a rotation speed of an engine 101, detected by a crank angle sensor 211, the target throttle opening calculation unit 304A of the target value calculation unit 310A calculates an opening of an electrically controlled throttle 201 which adjusts an air amount (intake air amount) flowing in the engine 101 and sends a control signal based on a result of the calculation (target throttle opening) to the electrically controlled throttle 201 of the engine 101.

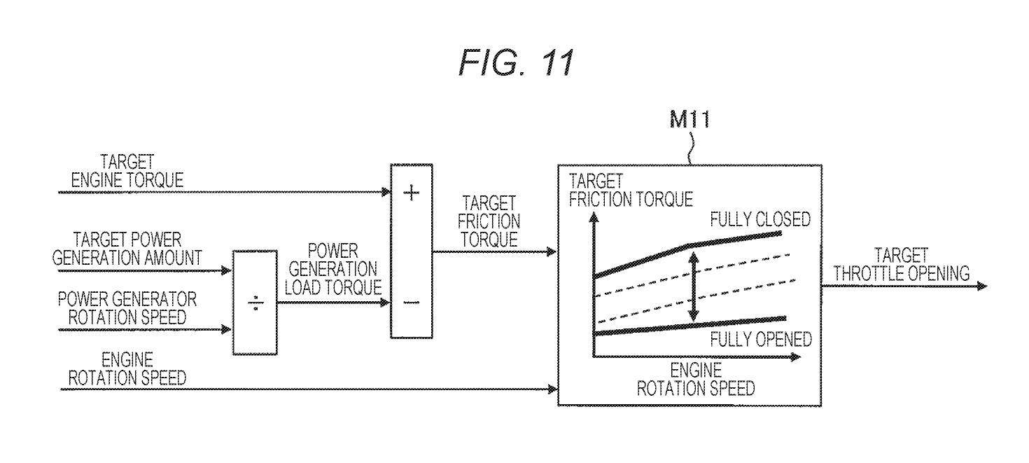

Specifically, the target throttle opening calculation unit 304A, as illustrated in FIG. 11, calculates power generation load torque of the power generator 106 by dividing a target power generation amount calculated by the target power generation amount calculation unit 305A by a rotation speed of the power generator 106 detected in advance. A rotation speed of the power generator 106 may be detected by information provided from a rotation speed sensor attached to the power generator 106. Further, in the case where a driving belt 107 is a fixed pulley like an alternator, a rotation speed of the engine 101 is obtained, and the rotation speed may be estimated based on a value obtained by multiplying a ratio of the fixed pulley to a rotation speed of the engine 101.

Further, the target throttle opening calculation unit 304A calculates target friction torque by subtracting a power generation load torque from a target engine torque calculated by the target engine torque calculation unit 802A. Specifically, the target throttle opening calculation unit 304A calculates a torque which cannot be covered by a power generation torque as a target friction torque and outputs the torque to achieve a target engine torque. The target throttle opening calculation unit 304A calculates a target throttle opening based on a map M11 specifying a relation among a rotation speed of the engine 101, a target friction torque, and a target throttle opening, which are memorized in advance.

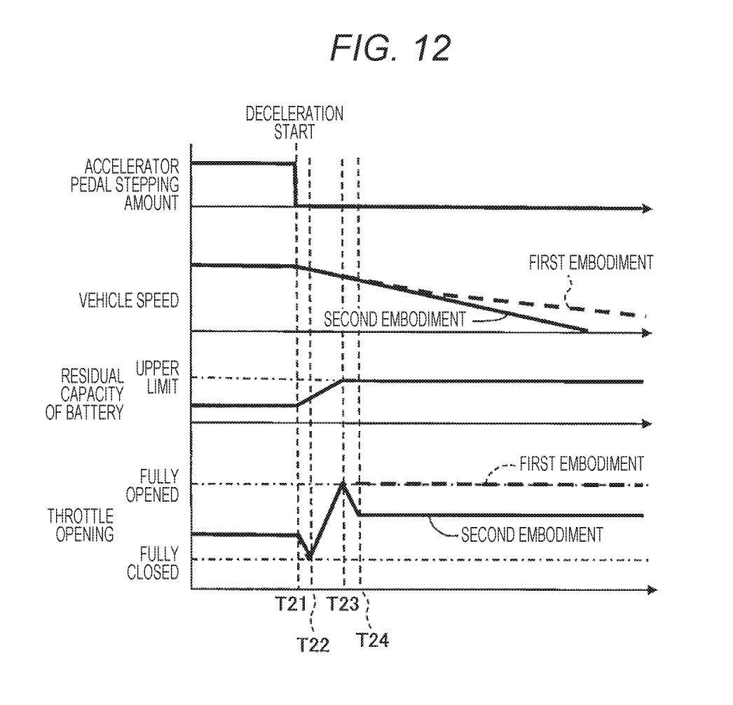

As described above, in the controller 111A according to the second embodiment, the target power generation amount calculation unit 305A calculates a target power generation amount based on a state of charge (residual capacity SOC) of the battery 108, and the target throttle opening calculation unit 304A calculates a target throttle opening based on a target power generation amount thereof. Accordingly, as illustrated in FIG. 12, a desired target driving force can be realized by adjusting an opening of the electrically controlled throttle 201 in accordance with a state of charge of the battery 108 (time T23 to T24) while efficiently charging the battery 108 (time T21 to T23). Therefore, operation performance of the vehicle 100 can be improved by suppressing variation of a deceleration of the vehicle 100 caused by the residual capacity SOC of the battery 108 while securing recovery energy of the battery 108.

### Third Embodiment

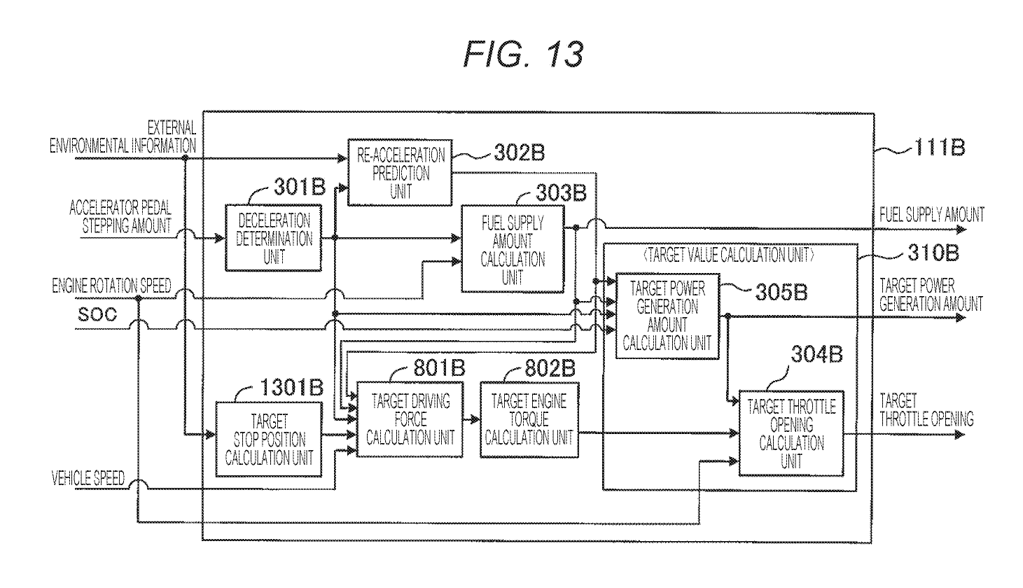

FIG. 13 schematically illustrates an internal configuration of a third embodiment of a vehicle control device according to the present invention. In a vehicle control device according to the third embodiment, mainly a configuration of a target driving force calculation unit is different from that of the vehicle control device according to the second embodiment, and other configurations are same as those of the vehicle control device according to the second embodiment. Therefore, the same configurations as those of the vehicle control device according to the second embodiment are denoted by the same reference signs, and detailed descriptions thereof are omitted.

As illustrated, the controller 111 mainly includes a deceleration determination unit 301B, a re-acceleration prediction unit 302B, a fuel supply amount calculation unit 303B, a target stop position calculation unit 1301, and a target driving force calculation unit 801B, a target engine torque calculation unit 802B, and a target value calculation unit 310B. The target value calculation unit 310B includes a target throttle opening calculation unit 304B and a target power generation amount calculation unit 305B.

The target stop position calculation unit 1301B calculates a target stop position where a vehicle 100 should stop, based on external environmental information on the vehicle 100 which is provided from an external environmental information acquisition device 112. Specifically, the target stop position calculation unit 1301B determines whether the vehicle 100 should stop, based, on whether a signal nearest from an own vehicle is a stop signal, whether a vehicle in front of the own vehicle is stopping, and whether there is a stop line ahead of the own vehicle. Then, the target stop position calculation unit 1301B calculates a target stop position by determining that the vehicle 100 should stop when detecting that the signal nearest from the own vehicle is a stop signal, the vehicle in front of the own vehicle is stopping, and there is the stop line ahead of the vehicle. For example, the target stop position is set on an own vehicle side by a predetermined value from a signal ahead of the own vehicle, a back side position of a front vehicle, and a stop line ahead of the own vehicle in external environmental information provided by the external environmental information acquisition device 112. In the case where a collision prevention brake mechanism is mounted on the vehicle 100, the target stop position may be set to such as a stop position in operation of a collision prevention brake.

The target driving force calculation unit 801B calculates a target driving force based on a determination result sent from the deceleration determination unit 301B, a calculation result (fuel supply amount) sent from the fuel supply amount calculation unit 303B, a prediction result sent from the re-acceleration prediction unit 302B, a calculation result (target stop position) sent from the target stop position calculation unit 1301B, and a vehicle speed of the vehicle 100 sent from the vehicle speed detector 115. Then, the target driving force calculation unit 801B sends a result of the calculation (target driving force) to the target engine torque calculation unit 802B.

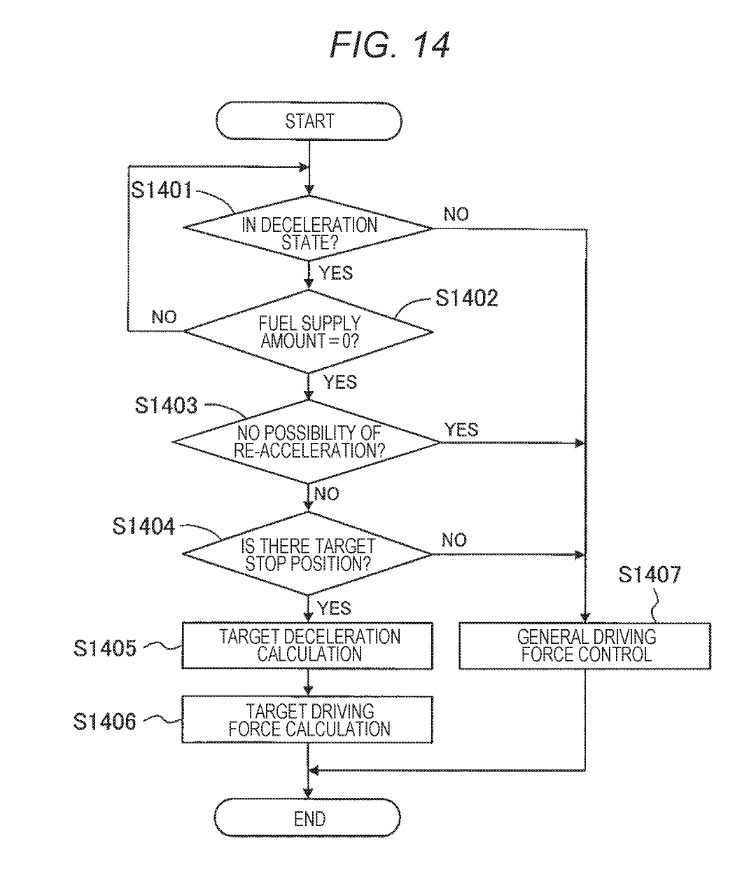

Specifically, the target driving force calculation unit 801B, as illustrated in FIG. 14, determines based on a determination result sent from the deceleration determination unit 301B whether the vehicle 100 is in a deceleration state (S1401). When the target driving force calculation unit 801B determines that the vehicle 100 is in a deceleration state, it determines whether a fuel supply amount sent from the fuel supply amount calculation unit 303B is zero (S1402). When an opening of the electrically controlled throttle 201 is set small (for example, a near fully closed position), and it is determined that a fuel supply amount to the engine 101 is zero, the target driving force calculation unit 801B determines based on a prediction result sent from the re-acceleration prediction unit 302B whether the vehicle 100 is likely to re-accelerate from a deceleration state (S1403). When the target driving force calculation unit 801B determines that the vehicle 100 is not likely to re-accelerate, it determines based on a target stop position sent from the target stop position calculation unit 1301B whether there is a target stop position (S1404). Next, when the target driving force calculation unit 801B determines that there is a target stop position, it calculates a distance Xstop between the target stop position and an own vehicle, and also calculates, by the following formula (2), a target deceleration (an acceleration to the rear side of a vehicle becomes positive) TG_α based on a vehicle speed V of the vehicle 100 and the distance Xstop (S1405).

$$\begin{matrix}[ Mathematical Formula 2 ] & \\ TG\_α = \frac{{V}^{2}}{2 \cdot Xstop} & ( 2 )\end{matrix}$$

The target driving force calculation unit 801B calculates a target driving force TG_FA (a force toward a front side of the vehicle becomes positive) based on a target deceleration TG_α calculated in S1405 by the following formula 3 (S1406). In the following formula 3, M denotes a vehicle weight, Cd denotes a coefficient of drag, S denotes a frontal projected area, V denotes a vehicle speed, g denotes a gravity acceleration, θ denotes a road surface gradient, and u denotes a rolling resistance coefficient. In the following formula 3, values in parenthesis can be called a running resistance of a vehicle.

[Mathematical Formula 3]

TG_FA=(Cd·S·V+u·M·g+M·g·sin θ)−M·TG_α (3)

As the distance Xstop between a target stop position and an own vehicle increases, the target deceleration TG_α needs to be decreased. However, if the target deceleration TG_α is excessively decreased, the target driving force TG_FA becomes positive and a driving force is generated to the vehicle 100 even while the vehicle 100 is decelerating. To adjust a target throttle opening of the electrically controlled throttle 201 within a range in which a driving force is not generated to the vehicle 100 in deceleration, the target deceleration TG_α for calculating the target driving force TG_FA is preferably set so as to satisfy a relation indicated by the following formula 4.

$$\begin{matrix}[ Mathematical Formula 4 ] & \\ α ≧ \frac{( M \cdot g \cdot sin θ + u \cdot M \cdot g + Cd \cdot S \cdot {V}^{2} )}{M} & ( 4 )\end{matrix}$$

On the other hand, when it is determined that the vehicle 100 is not in a deceleration state, when it is determined that the vehicle 100 is likely to re-accelerate, and when it is determined that a target stop position is not found, general driving force control is performed, for example, in accordance with an accelerator pedal stepping amount and a vehicle speed of the vehicle 100 (S1407). Specifically, the target driving force calculation unit 801B calculates a target driving force, for example, based on a calculation method described based on FIG. 10.

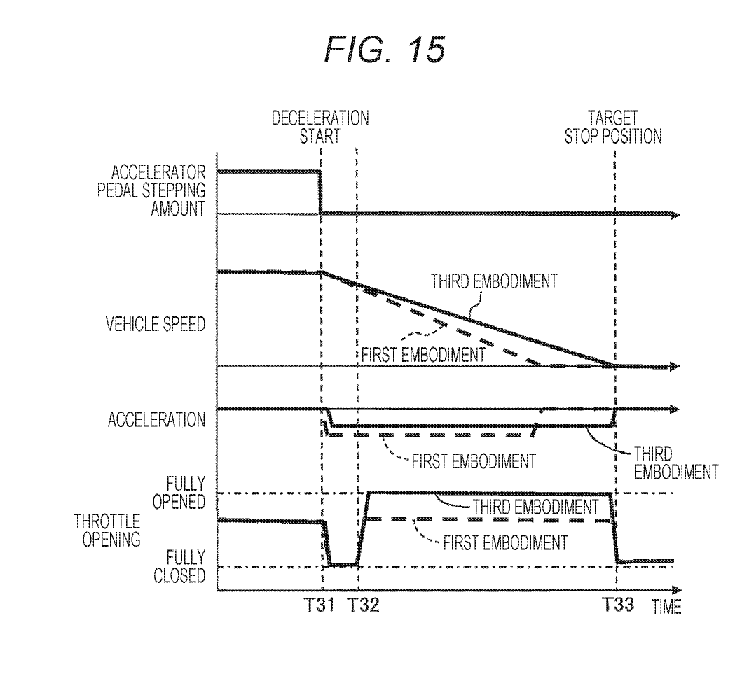

As described above, in the controller 111B according to the third embodiment, the target stop position calculation unit 1301B calculates a target stop position based on external environmental information on the vehicle 100, the target driving force calculation unit 801B calculates a target driving force based on the target stop position, the target power generation amount calculation unit 305B calculates a target power generation amount, and the target throttle opening calculation unit 304B calculates a target throttle opening based on the target power generation amount. Accordingly, as illustrated in FIG. 15, the vehicle 100 is decelerated at a deceleration in accordance with a target stop position where the vehicle 100 should stop, an opening of the electrically controlled throttle 201 is adjusted in accordance with the deceleration (especially time T32 to T33), and consequently kinetic energy loss can be suppressed. Therefore, the vehicle 100 can be stopped at a target stop position by efficiently decelerating the vehicle 100, and also fuel consumption performance of the vehicle 100 can be improved by increasing recovery energy of the battery 108.

### Fourth Embodiment

in the case where a coast stop mechanism is mounted on a vehicle 100, restart of an engine 101 in deceleration is suppressed by switching deceleration by an engine brake and deceleration by coast stop, and fuel consumption performance of the vehicle 100 can be improved. A coast stop mechanism is a mechanism in which the vehicle 100 is coasted by stopping the engine 101 by cutting off fuel supply to the engine 101 in deceleration of the vehicle 100 and releasing such as a clutch. On the other hand, when the vehicle 100 is decelerated by coast stop, the engine 101 stops and a power generator 106 also stops. Therefore, kinetic energy of the vehicle 100 cannot be recovered as electric energy, and fuel consumption performance of the vehicle 100 may be degraded.

Therefore, in a vehicle control device according to the fourth embodiment, based on external environmental information on the vehicle 100, deceleration by an engine brake and deceleration by coast stop are switched at an appropriate timing in accordance with a running state of the vehicle 100. Accordingly recovery energy of a battery 108 is secured, and fuel consumption performance of the vehicle 100 is improved.

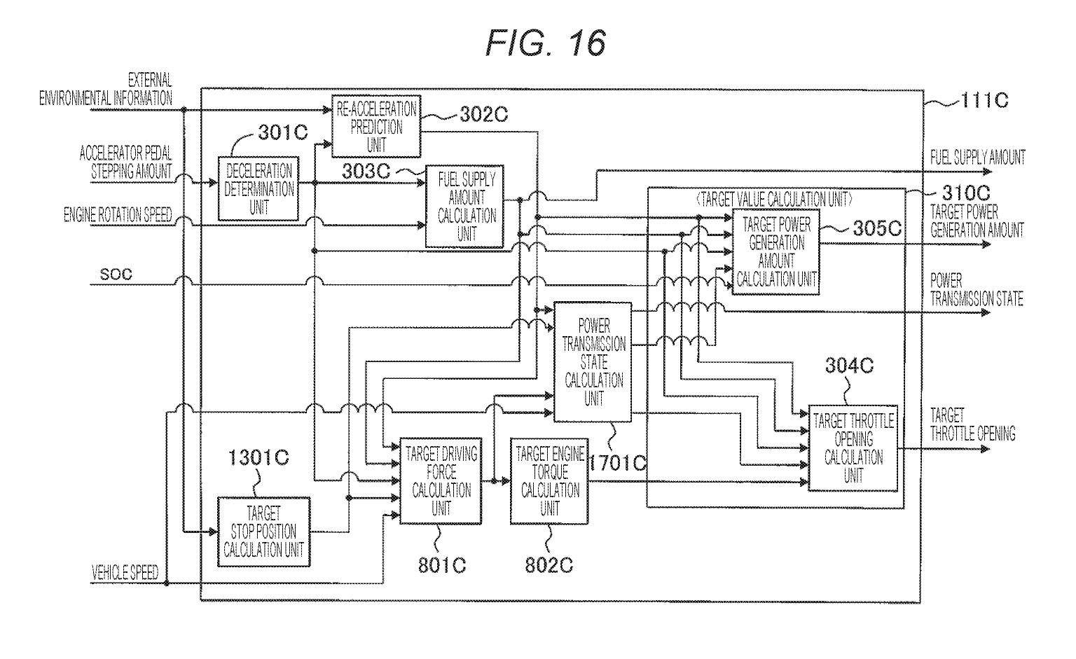

FIG. 16 schematically illustrates an internal configuration of the fourth embodiment of the vehicle control device according to the present invention. In the vehicle control device according to the fourth embodiment, in comparison with the above-described vehicle control device according to the third embodiment, a point in which a power transmission state calculation unit is added and a configuration of a target value calculation unit is mainly different, and other configurations are same as those of the vehicle control device according to the third embodiment. Therefore, the same configurations as those of the vehicle control device according to the third embodiment are denoted by the same reference signs, and detailed descriptions thereof are omitted.

As illustrated, a controller 111C mainly includes a deceleration determination unit 301C, a re-acceleration prediction unit 302C, a fuel supply amount calculation unit 303C, a target stop position calculation unit 1301C, and a target driving force calculation unit 801C, a target engine torque calculation unit 802C, a power transmission state calculation unit 1701C, and a target value calculation unit 310C. The target value calculation unit 310C includes a target throttle opening calculation unit 304C and a target power generation amount calculation unit 305C.

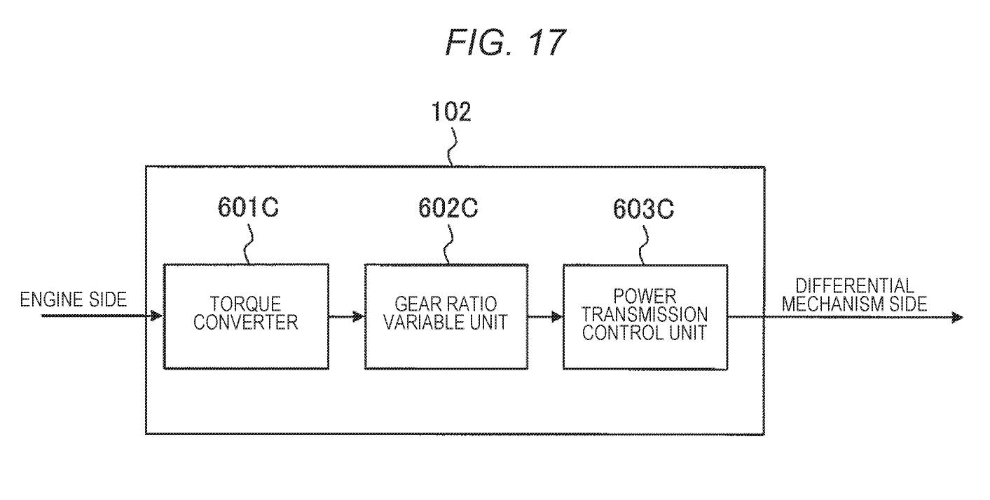

To realize the above-described coast stop mechanism, a transmission 102 provided between the engine 101 and a differential mechanism 103 includes a torque converter 601C, a gear ratio variable unit 602C, and a power transmission control unit 603C as illustrated in FIG. 17. The transmission 102 receives an output torque from the engine 101 side by the torque converter 601C including a lock-up clutch mechanism, changes a gear ratio by the gear ratio variable unit 602C, and controls whether to transmit power of the engine 101 to the differential mechanism 103 side by the power transmission control unit 603C including a dry clutch or a wet clutch. The gear ratio variable unit 602C may be an automatic transmission including multiple gears and may be a stepless transmission which can continuously varies a gear ratio by adjusting pulley width on an input side/an output side.

A control signal regarding a power transmission state is sent from the power transmission state calculation unit 1701C of the controller 111C to the power transmission control unit 603C, and based on the control signal, the power transmission control unit 603C transmits and cuts off power between the engine 101 and the differential mechanism 103 (specifically, a drive wheel 104 of the vehicle 100). Accordingly, deceleration by an engine brake and deceleration by coast stop can be switched while the vehicle 100 is decelerating.

The above-described power transmission state calculation unit 1701C is, as illustrated in FIG. 16, calculates a power transmission state in the power transmission control unit 603C based on such as a calculation result (target stop position) sent from the target stop position calculation unit 1301C, and sends a result of the calculation (power transmission state) to the target throttle opening calculation unit 304C and the target power generation amount calculation unit 305C of the target value calculation unit 310C.

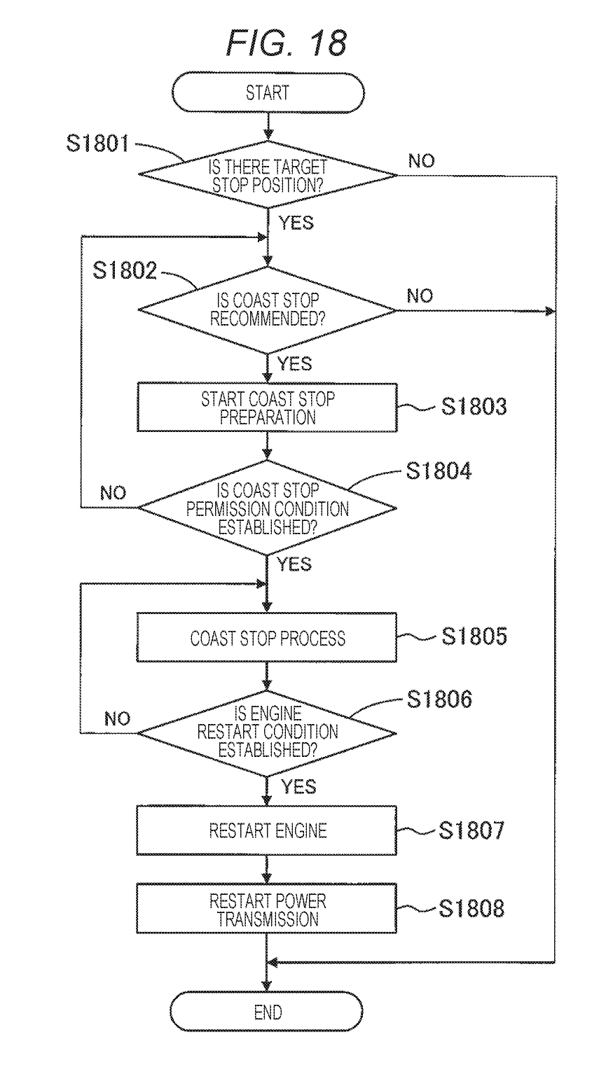

Specifically, the power transmission state calculation unit 1701C is, as illustrated in FIG. 18, determines based on a target stop position sent from the target stop position calculation unit 1301C whether there is a target stop position (S1801). When the power transmission state calculation unit 1701C determines that there is a target stop position, it determines whether to recommend coast stop (S1802). The power transmission state calculation unit 1701C calculates the distance Xstop from an own vehicle to a target stop position and a distance Xc reachable by coast stop and determines that coast stop is recommended when the distance Xstop is equal to or greater than the distance Xc, to avoid a possibility that the vehicle 100 is re-accelerated without reaching to a target stop position by coast stop deceleration and fuel consumption performance of the vehicle 100 is degraded. When a rotation speed of the engine 101 becomes a predetermined value or less during deceleration, the engine 100 may be restarted, and unnecessary fuel may be consumed. Therefore, the power transmission state calculation unit 1701C may determine that coast stop is recommended when a rotation speed of the engine 101 is the predetermined value or less even when the distance Xstop is smaller than the distance Xc.

The distance Xc reachable by coast stop is calculated by the following formula 5 based on a vehicle speed V of the vehicle 100 detected by the vehicle speed detector 115 and a deceleration αc (an acceleration to the rear side of a vehicle is positive) when coast stop is performed.

$$\begin{matrix}[ Mathematical Formula 5 ] & \\ Xc = \frac{{V}^{2}}{2 \cdot α c} & ( 5 )\end{matrix}$$

The deceleration αc when coast stop is performed is calculated by the following formula 6. In the following formula 6, M denotes a vehicle weight, Cd denotes a coefficient of drag, S denotes a frontal projected area, V denotes a vehicle speed, g denotes a gravity acceleration, θ denotes a road surface gradient, and u denotes a rolling resistance coefficient.

$$\begin{matrix}[ Mathematical Formula 6 ] & \\ α c = \frac{( Cd \cdot S \cdot {V}^{2} + u \cdot M \cdot g + M \cdot g \cdot sin θ )}{M} & ( 6 )\end{matrix}$$

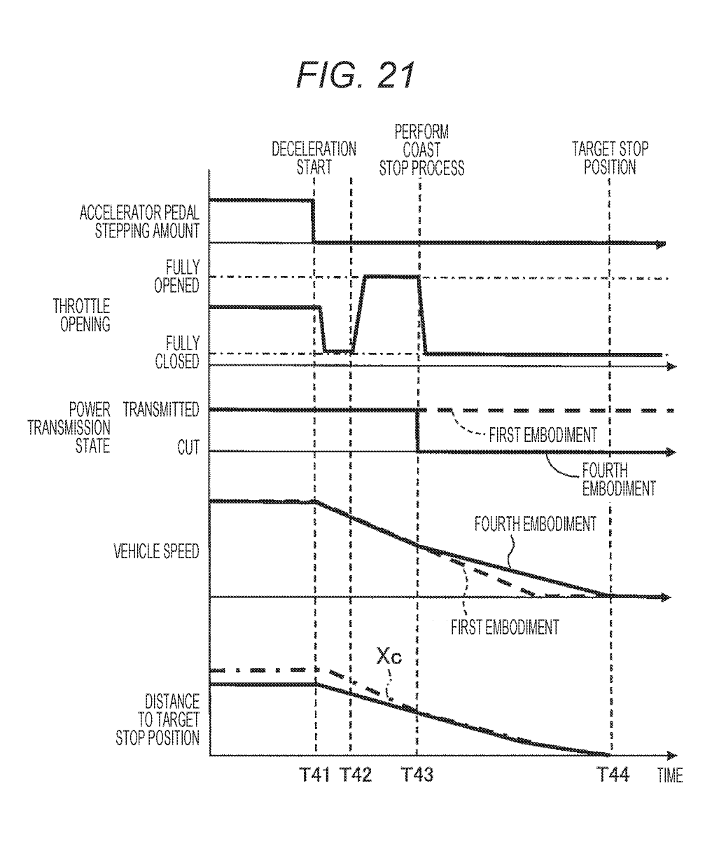

Next, the power transmission state calculation unit 1701C starts preparation for coast stop when it determines that coast stop is recommended (S1803). Specifically, as a pretreatment before power transmission is released (cut off) by the power transmission control unit 603C, while an electrically controlled throttle 201 is gradually opened to a near fully opened position, a power generation amount (target power generation amount) of the power generator 106 is reduced to zero, and a load torque of the power generator 106 is reduced (time T42 to T43 in FIG. 21).

Next, the power transmission state calculation unit 1701C determines whether to establish coast stop permission conditions, specifically determines whether to complete the above-described pretreatment (S1804). When the power transmission state calculation unit 1701C determines that the coast stop permission conditions are established, the power transmission control unit 603C cuts off power transmission between the engine 101 and the differential mechanism 103, and a coast stop process is performed (S1805) (time T43 in FIG. 21). The power transmission state calculation unit 1701C periodically determines whether engine restart conditions are established (S1806), and the coast stop process is maintained until the power transmission state calculation unit 1701C determines that engine restart conditions are established. In such a case, a target throttle opening of the electrically controlled throttle 201 is set to near zero, and the electrically controlled throttle 201 is closed to a near fully closed position.

The power transmission state calculation unit 1701C periodically determines as engine restart conditions whether a residual capacity SOC of the battery 108 is a predetermined value or less, whether an electrical load of an in-vehicle electrical equipment 109 is high, whether an evaporator temperature is equal to or higher than a predetermined value, whether a brake negative pressure is reduced, and whether it is determined by the re-acceleration prediction unit 302C that the vehicle 100 is likely to re-accelerate. When at least one of them is established, it is determined that the engine restart conditions are established, and the engine 101 is restarted (S1807). After restart of the engine 101 is completed, power transmission between the engine 101 and the differential mechanism 103 is restarted by the power transmission control unit 603C (S1808).

Based on a determination result sent from the deceleration determination unit 301C, a calculation result (fuel supply amount) sent from the fuel supply amount calculation unit 303C, and a prediction result sent from the re-acceleration prediction unit 302C, and a calculation result (power transmission state) sent from the power transmission state calculation unit 1701C, the target throttle opening calculation unit 304C of the target value calculation unit 310C calculates an opening of the electrically controlled throttle 201 which adjusts an air amount (intake air amount) flowing in the engine 101, and sends a control signal based on a result of the calculation (target throttle opening) to the electrically controlled throttle 201 of the engine 101.

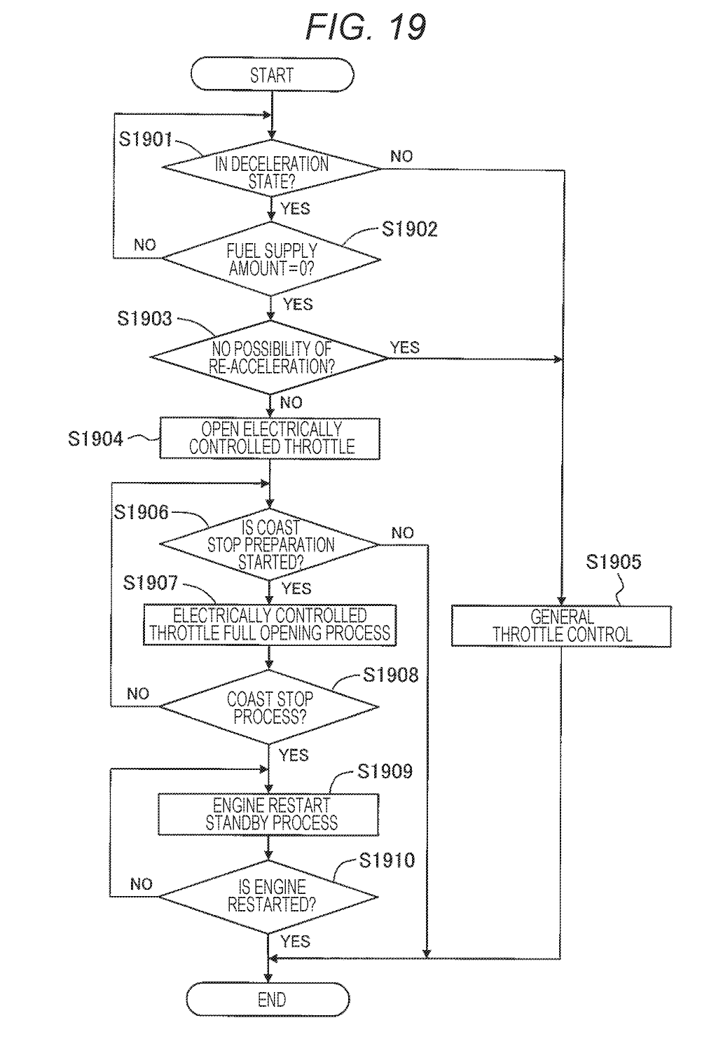

Specifically, the target throttle opening calculation unit 304C performs, as illustrated in FIG. 19, steps (S1901 to S1905) as with the first embodiment described based on FIG. 5, and the electrically controlled throttle 201 is gradually opened from a near fully closed position (S1904). Alternatively, for example, general throttle control in accordance with an accelerator pedal stepping amount is performed (S1905).

Next, the target throttle opening calculation unit 304C determines whether preparation for coast stop is started, based on a power transmission state sent from the power transmission state calculation unit 1701C (S1906). When it is determined that the preparation for coast stop is started (corresponding to S1803 in FIG. 18), the electrically controlled throttle 201 is fully opened to reduce torque shock when power transmission is released (S1907), and engine friction is reduced. The target throttle opening calculation unit 304C periodically determines whether a coast stop process is performed (S1908). The electrically controlled throttle 201 is maintained to full open until it is determined that the coast stop process is performed (time T42 to T43 in FIG. 21).

Next, when the target throttle opening calculation unit 304C determines that a coast stop process is performed (corresponding to S1805 in FIG. 18), it performs an engine restart standby process (S1909). Specifically, to suppress fuel consumption by unnecessary air flow when the engine 101 is restarted next time, the electrically controlled throttle 201 is controlled to a near fully closed position (time T43 in FIG. 21). Rotation of the engine 101 is stopped in a coast stop state, and even if an opening change (opening/closing speed of the electrically controlled throttle 201) of the electrically controlled throttle 201 per unit time is increased, torque shock is not generated. Therefore, the electrically controlled throttle 201 is immediately controlled to a near fully closed position to shorten a preparation time for restarting the engine 101 next time.

The target throttle opening calculation unit 304C determines whether the engine 101 restarts, based on a power transmission state sent from the power transmission state calculation unit 1701C (S1910). When the target throttle opening calculation unit 304C determines that the engine 101 restarts (corresponding to S1807 in FIG. 18), the calculation process is finished.

Further, based on a determination result sent from the deceleration determination unit 301C, a residual capacity SOC of the battery 108 sent from the battery state detector 110, a calculation result (a fuel supply amount) sent from the fuel supply amount calculation unit 303C, a prediction result sent from the re-acceleration prediction unit 302C, and a calculation result (power transmission state) sent from the power transmission state calculation unit 1701C, the target power generation amount calculation unit 305C of the target value calculation unit 310C calculates a power generation amount of the power generator 106 which adjusts a state of charge of the battery 108 and sends a control signal based on a result of the calculation (target power generation amount) to the power generator 106.

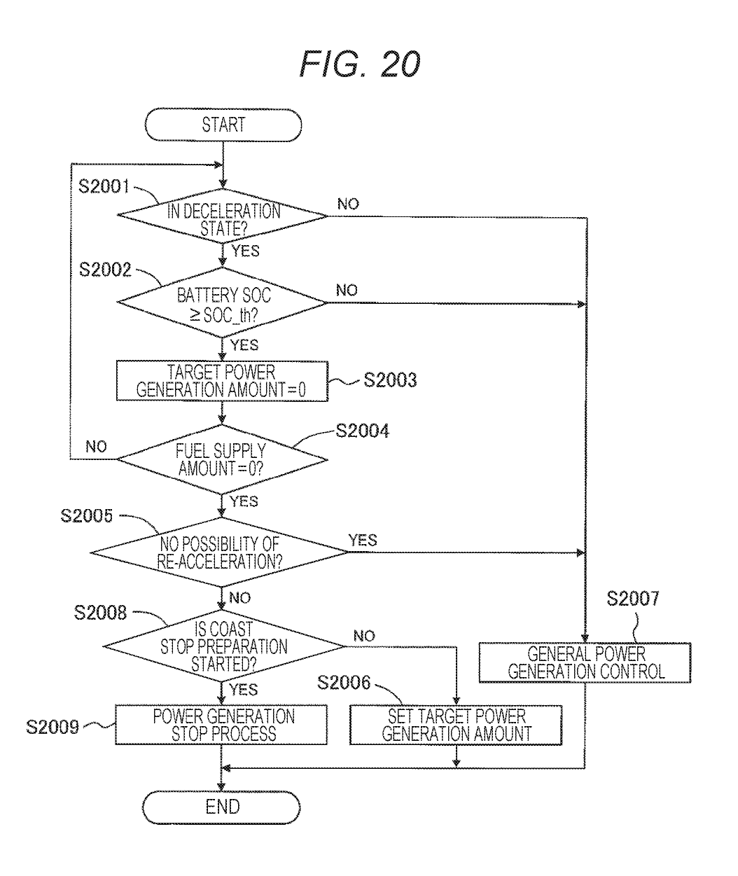

Specifically, the target power generation amount calculation unit 305C performs, as illustrated in FIG. 20, flows (S2001 to S2005, and S2007) as with the first embodiment described based on FIG. 7. Further, the target power generation amount calculation unit 305C determines whether preparation for coast stop is started, based on a power transmission state sent from the power transmission state calculation unit 1701C (S2008). When the target power generation amount calculation unit 305C determines that the preparation for coast stop is started (corresponding to S1803 in FIG. 18), a power generation amount (target power generation amount) of the power generator 106 is gradually reduced to zero to suppress torque shock in coast stop by decreasing a power generation load by the power generator 106 (S2009). On the other hand, when the target power generation amount calculation unit 305C determines that the preparation for coast stop is not started, as with the first embodiment described based on FIG. 7, a target power generation amount is set so that a power generation amount of the power generator 106 becomes maximum (S2006).

As described above, in the controller 111C according to the fourth embodiment, a power transmission status between the engine 101 and the drive wheel 104 is changed in accordance with a target stop position calculated based on external environmental information on the vehicle 100, and a fuel consumption performance of the vehicle 100 can be further improved by securing recovery energy of the battery 108 by switching deceleration by an engine brake and deceleration by coast stop at an appropriate timing in accordance with a traveling state of the vehicle 100. Further, by performing coast stop in a low rotation region of the engine 101 while the vehicle 100 is decelerating, deterioration of fuel consumption caused by fuel re-supply can be suppressed. Further, by largely opening the electrically controlled throttle 201 and by reducing a power generation amount of the power generator 106 before a coast stop process is performed, torque shock can be effectively reduced which might be caused by switching from deceleration by an engine brake to deceleration by coast stop.

In the above-described fourth embodiment, it has been described that the target throttle opening calculation unit 304C calculates an opening of the electrically controlled throttle 201 based on a determination result sent from the deceleration determination unit 301C, a fuel supply amount sent from the fuel supply amount calculation unit 303C, a prediction result sent from the re-acceleration prediction unit 302C, and a power transmission state sent from the power transmission state calculation unit 1701C. However, for example, as with the second and third embodiments, the target throttle opening calculation unit 304C may calculate an opening of the electrically controlled throttle 201 based on a target engine torque sent from the target engine torque calculation unit 802C, a target power generation amount sent from the target power generation amount calculation unit 305C, a rotation speed of the engine 101 detected by the crank angle sensor 211, and a power transmission state sent from the power transmission state calculation unit 1701C.

The present invention is not limited to the above-described first to fourth embodiments and includes various variations. For example, the above-described first to fourth embodiments describe the present invention in detail for clarification, and every configurations described above may not be necessarily included. Further, a configuration of each embodiment can be partially replaced to configurations of the other embodiments. Furthermore, a configuration of each embodiment can be added to configurations of the other embodiments. Further, a part of a configuration of each embodiment can be added to, deleted from, and replaced from other configurations.

Further, each of the above-described configurations, functions, process units, and process means may be realized by a hardware, for example, by designing a part of or all of them by using an integrated circuit. Further, each of the configurations and the functions may be realized by a software by interpreting and performing a program for realizing each function by a processor. Information on such as a program, a table, and a file for realizing each function can be stored in a storage device such as a memory, a hard disc, and a solid state drive (SSD) or a storage medium such as an IC card, an SD card, and DVD.

Further, control lines and information lines which are considered to be necessary for description are indicated, and all of control lines and information lines on the product are not necessarily indicated. It may be considered that almost all of the configurations are actually connected each other.

### REFERENCE SIGNS LIST

100 vehicle
101 engine
102 transmission
103 differential mechanism
104 drive wheel
105 starter motor
106 power generator
107 driving belt
108 battery
109 in-vehicle electrical equipment
110 battery state detector
111, 111A, 111B, 111C controller
112 external environmental information acquisition device
113 accelerator pedal stepping amount detector
114 brake pedal stepping amount detector
115 vehicle speed detector
201 electrically controlled throttle (throttle)
202 air cleaner
203 intake pipe
204 airflow sensor
205 fuel injector
206 collector
207 intake valve
208 combustion chamber
209 piston
210 ignition plug
211 crank angle sensor
212 exhaust valve
213 exhaust manifold
214 three-way catalyst
215 air fuel ratio sensor
216 intake manifold
301, 301A, 301B, 301C deceleration determination unit
302, 302A, 302B, 302C re-acceleration prediction unit
303, 303A, 303B, 303C fuel supply amount calculation unit
304, 304A, 304B, 304C target throttle opening calculation unit
305, 305A, 305B, 305C target power generation amount calculation unit
310, 310A, 310B, 310C target value calculation unit
601C torque converter
602C gear ratio variable unit.
603C power transmission control unit
801A, 801B, 801C target driving force calculation unit
802A, 802B, 802C target engine torque calculation unit
1301B, 1301C target stop position calculation unit
1701C power transmission state calculation unit

1.-20. (canceled)

21. A vehicle control device configured to control fuel consumption performance of a vehicle by adjusting a load of an engine and a state of charge of a battery, which are mounted on the vehicle,
the vehicle control device comprising:
a re-acceleration prediction unit configured to predict re-acceleration from a deceleration state of the vehicle based on external environmental information;
a target value calculation unit configured to calculate a target throttle opening of a throttle configured to adjust an amount of air flowing in the engine and a target power generation amount of a power generator configured to supply power to the battery by being driven by the engine, based on a prediction result by the re-acceleration prediction unit; and
a power transmission state calculation unit configured to calculate a transmission state of power transmitted between the engine and a drive wheel of the vehicle,
wherein the target value calculation unit calculates the target throttle opening and the target power generation amount based on the prediction result by the re-acceleration prediction unit and a calculation result by the power transmission state calculation unit.

22. The vehicle control device according to claim 21, wherein
the target value calculation unit comprises a target power generation amount calculation unit configured to calculate the target power generation amount based on a prediction result by the re-acceleration prediction unit and
a target throttle opening calculation unit configured to calculate the target throttle opening based on a prediction result by the re-acceleration prediction unit.

23. The vehicle control device according to claim 21, wherein
the target value calculation unit comprises a target power generation amount calculation unit configured to calculate the target power generation amount based on a prediction result by the re-acceleration prediction unit and
a target throttle opening calculation unit configured to calculate the target throttle opening based on a calculation result by the target power generation amount calculation unit.

24. The vehicle control device according to claim 23, further comprising a target driving force calculation unit configured to calculate a target driving force of the vehicle, and a target engine torque calculation unit configured to calculate a target engine torque of the engine based on a calculation result by the target driving force calculation unit,
wherein the target throttle opening calculation unit calculates the target throttle opening based on a calculation result by the target power generation amount calculation unit and a calculation result by the target engine torque calculation unit.

25. The vehicle control device according to claim 24, further comprising a target stop position calculation unit configured to calculate a target stop position of the vehicle based on external environmental information,
wherein the target driving force calculation unit calculates the target driving force based on a calculation result by the target stop position calculation unit.

26. The vehicle control device according to claim 21, wherein the target value calculation unit comprises a target power generation amount calculation unit configured to calculate the target power generation amount based on a prediction result by the re-acceleration prediction unit and a calculation result by the power transmission state calculation unit, and a target throttle opening calculation unit configured to calculate the target throttle opening based on a prediction result by the re-acceleration prediction unit and a calculation result by the power transmission state calculation unit.

27. The vehicle control device according to claim 21, wherein the target value calculation unit comprises a target power generation amount calculation unit configured to calculate the target power generation amount based on a prediction result by the re-acceleration prediction unit and a calculation result by the power transmission state calculation unit, and a target throttle opening calculation unit configured to calculate the target throttle opening based on a calculation result by the target power generation amount calculation unit and a calculation result by the power transmission state calculation unit.

28. The vehicle control device according to claim 21, wherein the target value calculation unit sets the target throttle opening when it is predicted that the vehicle is not likely to re-accelerate so as to be larger than the target throttle opening when it is predicted that the vehicle is likely to re-accelerate.

29. The vehicle control device according to claim 28, wherein the target value calculation unit sets the target throttle opening to full open when it is predicted that the vehicle is not likely to re-accelerate.

30. The vehicle control device according to claim 21, wherein when fuel supply to the engine is stopped, the throttle is opened/closed based on the target throttle opening such that an opening/closing speed in a region in which the throttle opening is small becomes smaller than an opening/closing speed in a region in which the throttle opening is large.

31. A vehicle control device configured to control fuel consumption performance of a vehicle by adjusting a load of an engine and a state of charge of a battery, which are mounted on the vehicle,
the vehicle control device comprising:
a re-acceleration prediction unit configured to predict re-acceleration from a deceleration state of the vehicle based on external environmental information; and
a target value calculation unit configured to calculate a target throttle opening of a throttle configured to adjust an amount of air flowing in the engine and a target power generation amount of a power generator configured to supply power to the battery by being driven by the engine, based on a prediction result by the re-acceleration prediction unit,
wherein the target calculation unit sets the target power generation amount when predicting that the vehicle is not likely to re-accelerate larger than the target power generation amount when predicting that the vehicle is likely to re-accelerate.

32. The vehicle control device according to claim 24, wherein the target driving force calculation unit calculates the target driving force based on an accelerator pedal stepping amount and a vehicle speed.

33. The vehicle control device according to claim 24, wherein the target driving force calculation unit sets the target driving force so as not to generate acceleration forward of the vehicle.

34. The vehicle control device according to claim 21, further comprising a target stop position calculation unit configured to calculate a target stop position of the vehicle based on external environmental information,
wherein the power transmission state calculation unit cuts off power transmission between the engine and a drive wheel of the vehicle when a distance from the vehicle to the target stop position is equal to or larger than a distance in which the vehicle arrives in a state in which power transmission between the engine and a drive wheel of the vehicle is cut off or when a rotation speed of the engine is equal to or less than a rotation speed for re-supplying fuel.

35. The vehicle control device according to claim 21, wherein the power transmission state calculation unit sets the target throttle opening to full open before power transmission between the engine and a drive wheel of the vehicle is cut off.

36. The vehicle control device according to claim 35, wherein the power transmission state calculation unit sets the target throttle opening to full close after power transmission between the engine and a drive wheel of the vehicle is cut off.

37. The vehicle control device according to claim 21, wherein the power transmission state calculation unit sets the target power generation amount to zero before power transmission between the engine and a drive wheel of the vehicle is cut off.

38. The vehicle control device according to claim 21, wherein the re-acceleration prediction unit predicts that the vehicle is likely to re-accelerate when an accelerator pedal stepping amount is zero, and an inter-vehicle distance between the vehicle and a front vehicle is equal to or larger than a predetermined value and the vehicle is far from the front vehicle, or when the accelerator pedal stepping amount is zero, and an inter-vehicle distance between the vehicle and the front vehicle is equal to or larger than a predetermined value and acceleration of the front vehicle is equal to or larger than a predetermined value.

39. The vehicle control device according to claim 21, wherein the re-acceleration prediction unit predicts that the vehicle is likely to re-accelerate when the re-acceleration prediction unit determines that an external environmental information acquisition unit for acquiring external environmental information is broken.
